(19) United States
(12) Patent Application Publication
(10) Pub. No.: US 2023/0267669 A1
(43) Pub. Date: Aug. 24, 2023

(54) METHOD FOR GENERATING JOINT-BASED FACIAL RIG AND APPARATUS THEREFOR

(71) Applicant: Evr studio Co., Ltd, Seoul (KR)

(72) Inventors: Jae Wook PARK, Seoul (KR); Dong Joon Min, Seoul (KR)

(73) Assignee: Evr studio Co., Ltd, Seoul (KR)

(21) Appl. No.: 17/898,472

(22) Filed: Aug. 29, 2022

(30) Foreign Application Priority Data
Feb. 23, 2022 (KR) 10-2022-0023720

(51) Int. Cl. G06T 13/40; G06T 17/00

(52) U.S. Cl. CPC G06T 13/40; G06T 17/00

(57) ABSTRACT

Provided are a method for generating a joint-based facial rig and a 3D graphics interface apparatus therefor according to exemplary embodiments of the present disclosure. A method for generating a joint-based facial rig performed by a control unit includes: generating a facial rig model by morphing at least one morph target in order to represent a facial expression; generating at least one joint corresponding to each of a plurality of facial areas of the generated facial rig model; connecting the at least one generated joint and each of the plurality of facial areas; and moving each of at least one morph target corresponding to the facial rig model, and recording a movement change value of a joint moving jointly according to each moving morph target.

### CROSS-REFERENCE TO RELATED APPLICATIONS

This application claims the priority of Korean Patent Application No. 10-2022-0023720 filed on Feb. 23, 2022, in the Korean Intellectual Property Office, the disclosure of which is incorporated herein by reference.

### BACKGROUND OF THE DISCLOSURE

### Technical Field

The present disclosure relates to a method for generating a joint-based facial rig and an apparatus therefor.

### BACKGROUND ART

In general, three-dimensional graphics technology is a technology that creates and visualizes realistic three-dimensional objects. Three-dimensional graphics technology is used in various fields such as broadcasting, game, movies, and medical care. The three-dimensional objects are designed by producers by using a 3D graphics tool such as a 3D modeling software or an application. In recent years, in a field of graphics, various methods for expressing a person realistically and practically such as Digital Human have been developed.

Morphing-based facial rig is used to realize the Digital Human by realistically expressing the shape of a face. In other words, the morphing-based facial rig is used as a tool for expressing a realistic motion of a face by using hundreds of morphings.

### SUMMARY OF THE DISCLOSURE

When inventors of the present disclosure recognize that when using a morphing-based facial rig, a data capacity is large and a processing speed is slow as hundreds of morphings are used. And also, the inventors recognize that the morphing-based facial rig is difficult to use in a real-time engine or can be limitedly used in a high-performance computer.

Further, the inventors of the present disclosure recognize a fact that in a current Digital Human market, a real-time processing method for completing all processes within at least 1/60 seconds is requested not only rendering.

Therefore, an object to be achieved by the present disclosure is to provide a method and an apparatus for generating a joint-based facial rig.

Specifically, another object to be achieved by the present disclosure is to provide a method and an apparatus for generating a joint-based facial rig, that is processed dozens to approximately one hundred times or faster than a morphing-based facial rig and enables real-time processing as data capacity is reduced.

Further, yet another object to be achieved by the present disclosure is to provide a method and an apparatus for generating a joint-based facial rig that can be easily used in a real-time engine without a limit in computer performance.

The objects of the present disclosure are not limited to the aforementioned objects, and other objects, that are not mentioned above, will be apparent to a person having ordinary skills in the art from the following description.

In order to solve the problem, according to an aspect of the present disclosure, provided is a method for generating a joint-based facial rig. The method is configured to include: generating a facial rig model by morphing at least one morph target in order to represent a facial expression; generating at least one joint corresponding to each of a plurality of facial areas of the generated facial rig model; connecting the at least one generated joint and each of the plurality of facial areas; and moving each of at least one morph target corresponding to the facial rig model, and recording a movement change value of a joint moving jointly according to each moving morph target.

According to a feature of the present disclosure, the method may further include: releasing the connection between each of the plurality of facial areas of the facial rig model and the joint; and bind-skinning the joint connection-released from the facial rig model based on the recorded movement change value.

According to a feature of the present disclosure, the method may further include deleting remaining data other than the facial rig model of that the joint is bind-skinned.

According to a feature of the present disclosure, the remaining data may include at least one morph target and at least one of morphing rigs corresponding to at least one morph target.

According to a feature of the present disclosure, the generating of the facial rig model may further include generating a controller for controlling the at least one morph target.

According to a feature of the present disclosure, the generated controller may include an attribute value corresponding to each of the at least one morph target, and the at least one morph target may be morphed based on the attribute value.

According to a feature of the present disclosure, the method may further include: determining a location value for each joint by using a movement change value of at least one joint corresponding to the attribute value when the attribute value is changed; and moving the each joint with the determined location value.

In order to solve the problem, according to another aspect of the present disclosure, provided is a 3D graphics interface apparatus. The 3D graphics interface apparatus includes: a storage unit; and a processor configured to generate a facial rig model by morphing at least one morph target in order to represent a facial expression in connection with the storage unit, wherein the processor is configured to generate at least one joint corresponding to each of a plurality of facial areas of the generated facial rig model, connect the at least one generated joint and each of the plurality of facial areas, and operate each of at least one morph target corresponding to the facial rig model, and record a movement change value of a joint moving jointly according to each operating morph target.

According to a feature of the present disclosure, the processor is configured to release the connection between each of the plurality of facial areas of the facial rig model and the joint, and bind-skin the joint connection-released from the facial rig model based on the recorded movement change value.

According to a feature of the present disclosure, the processor may be further configured to delete remaining data other than the facial rig model of that the at least one joint is bind-skinned.

According to a feature of the present disclosure, the control unit may be further configured to generate a controller for controlling the at least one morph target.

According to a feature of the present disclosure, the control unit may be configured to determine a location value for each joint by using a movement change value of at least one joint corresponding to the attribute value when the attribute value is changed, and move the each joint with the determined location value.

Details of other exemplary embodiments will be included in the detailed description of the disclosure and the accompanying drawings.

According to the present disclosure, a joint-based facial rig model is generated by using a morphing-based facial rig model, the amount of data storage is minimized and a data processing speed is increased, and as a result, real-time processing and motion control are possible.

Further, according to the present disclosure, a joint-based facial rig model capable of expressing a detailed and delicate motion that is acquired by the morphing-based facial rig model.

The effects according to the present disclosure are not limited by the contents exemplified above, and other various effects are included in the present specification.

### BRIEF DESCRIPTION OF THE DRAWINGS

The above and other aspects, features, and other advantages of the present disclosure will be more clearly understood from the following detailed description taken in conjunction with the accompanying drawings, in which:

FIG. 1 is a schematic view for describing an apparatus for generating a joint-based facial rig according to an exemplary embodiment of the present disclosure;

FIG. 2 is an exemplary diagram for describing an operation of generating a joint in a facial rig model according to an exemplary embodiment of the present disclosure;

FIGS. 3 and 4 are exemplary diagrams for describing an operation of storing a motion change value of the joint according to an exemplary embodiment of the present disclosure;

FIG. 5 is an exemplary diagram for describing a method for generating a joint-based facial rig model according to an exemplary embodiment of the present disclosure; and

FIG. 6 is a flowchart for describing a method for generating a joint-based facial rig model according to an exemplary embodiment of the present disclosure.

### DETAILED DESCRIPTION OF THE EMBODIMENT

Advantages and features of the present disclosure, and methods for accomplishing the same will be more clearly understood from exemplary embodiments described in detail below with reference to the accompanying drawings. However, the present disclosure is not limited to the exemplary embodiments set forth below, and will be embodied in various different forms. The exemplary embodiments are just for rendering the disclosure of the present disclosure complete and are set forth to provide a complete understanding of the scope of the disclosure to a person with ordinary skill in the technical field to which the present disclosure pertains, and the present disclosure will only be defined by the scope of the claims. In connection with the description of the drawings, similar reference numerals may be used for similar components.

In the present disclosure, expressions such as “have”, “can have” “include,” or “can include”, etc., refers to the presence of the corresponding feature (e.g., a number, a function, an operation, or a component such as a part) and does not exclude the presence of an additional feature.

In the present disclosure, expressions such as “A or B”, “at least one of A and/or B”, or “one or more of A or/and B” may include all possible combinations of items listed together. For example, “A or B”, “at least one of A and B”, or “at least one of A or B” may refer to all cases of (1) including at least one A, (2) including at least one B, or (3) including both at least one A and at least one B.

Expressions such as “first” and “second” used in the present disclosure can modify various components regardless of their order and/or importance, and will be used only to distinguish one component from another component, but do not limit the components. For example, a first user device and a second user device may represent different user devices regardless of the order or the importance. For example, a first component may be referred to as a second component, and similarly, the second component may be changed and referred to as the first component without departing from the scope disclosed in the present disclosure.

When any component (e.g., first component) is referred to as being “(operatively or communicatively) coupled” or “connected” with/to the other component (e.g., second component), the component may be directly coupled with/to the other component, or may be coupled through another component (e.g., a third component). On the contrary, when it is mentioned that any component (e.g., first component) is “directly coupled” or “directly connected” with/to the other component (e.g., second component), it may be appreciated that another component (e.g., third component) is not present between the any component and the other component.

An expression “configured to” used in the present disclosure may be used interchangeably with, for example, “suitable for,” “having the capacity to,” “designed to”, “adapted to”, “made to”, or “capable of” depending on the situation. The term “configured (set) to” may not particularly mean only “specifically designed to” in terms of hardware. Instead, in some situations, the expression “a device configured to” may mean that the device is “capable of” together with other devices or parts. For example, the phrase “a processor configured (set) to perform A, B, and C” may mean a dedicated processor (e.g., an embedded processor) for performing the operation, or a generic-purpose processor (e.g., a CPU or application processor) capable of performing the corresponding operations by executing one or more software programs stored in a memory device.

The terms used in the present disclosure are used to describe a specific exemplary embodiment, and may not be intended to limit the scope of other exemplary embodiments. A singular form may include a plural form unless otherwise clearly meant in the contexts. The terms used herein including technological or scientific terms have the same meanings as those generally understood by a person with ordinary skill in the art. The terms defined in the general dictionary of the terms used in the present disclosure can be interpreted as the same or similar meaning as the context of the relevant technology, and unless defined clearly in the present disclosure, the terms are not interpreted as ideal or excessively formal meanings. In some cases, even a term defined in the present disclosure cannot be interpreted to exclude the exemplary embodiments of the present disclosure.

The features of various exemplary embodiments of the present disclosure can be partially or entirely bonded to or combined with each other and can be interlocked and operated in technically various ways to be sufficiently appreciated by those skilled in the art, and the exemplary embodiments can be carried out independently of or in association with each other.

Hereinafter, terms used in the present specification will be organized in brief in order to help to understand disclosures presented in the present specification.

In the present specification, morphing (blend shape) means a technology that may generate a new facial shape through linear interpolation between models having a basic expression model (e.g., absence of expression) and another expression.

In the present specification, the model means a head object configured by geometry. The model has a basic expression or each facial expression figure on a facial action coding system (FACS).

In the present specification, the geometry means a 3D model expressed by a mesh that is a 3D plane created through 3D modeling by using a vertex, a line, and a polygon.

In the present specification, FACS, as a method for analyzing a facial expression of a person based on anatomical facial muscles of the person. FACS is constituted by an action unit and facial action descriptors.

In the present specification, the action unit means a basic unit of an expression formed by individual facial muscles or a combination of a plurality of facial muscles. The facial expression may be constituted by an action unit alone or a combination of two or more action units.

Hereinafter, various exemplary embodiments of the present disclosure will be described in detail with reference to the accompanying drawings.

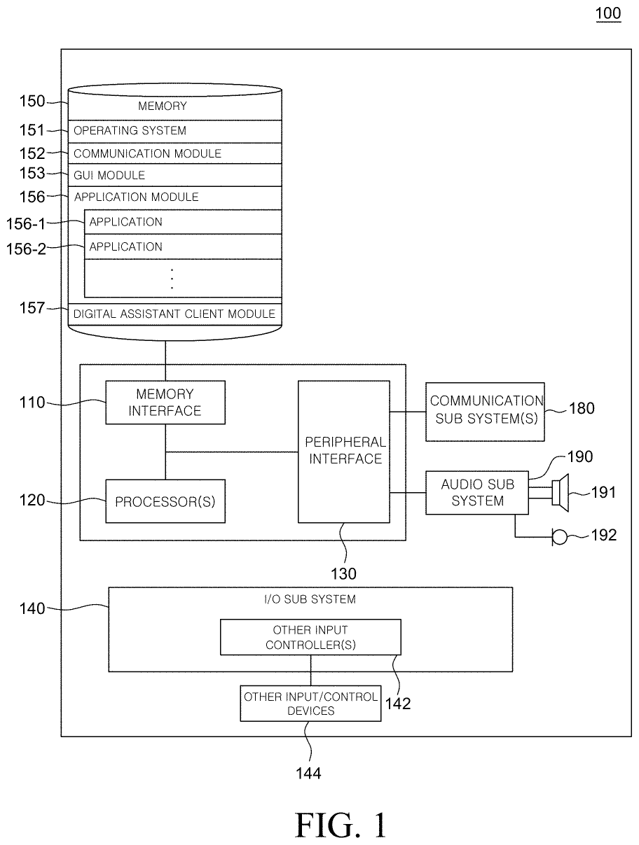

FIG. 1 is a schematic view for describing an apparatus for generating a joint-based facial rig according to an exemplary embodiment of the present disclosure.

Referring to FIG. 1, a 3D graphics interface apparatus 100 may include a memory interface 110, one or more processors 120, and a peripheral interface 130. Various components in the 3D graphics interface apparatus 100 may be connected by one or more communication buses or signal lines.

The memory interface 110 is connected to the memory 150 to transfer various data to the processor 120. Here, the memory 150 may include at least one type of storage medium of a flash memory type, a hard disk type, a multimedia card micro type, a card type memory (e.g., an SD or XD memory), a RAM, an SRAM, a ROM, an EEPROM, a PROM, a network storage, a cloud, and a blockchain database.

In various exemplary embodiments, the memory 150 may store at least one of an operating system 151, a communication module 152, a graphical user interface module (GUI) 153, a sensor processing module 154, and an application module 156. Specifically, the operating system 151 may include a command for processing a basic system service and a command for performing hardware tasks. The communication module 152 may communicate with at least one of one or more other devices, computers, and servers. The graphical user interface module (GUI) 153 may process the graphical user interface. The application module 156 may perform various functions of a user application, e.g., electronic messaging, web browsing, media processing, searching, imaging, and other process functions. Moreover, the 3D graphics interface apparatus 100 may store one or more software applications 156-1 and 156-2 (e.g., fan meeting application) related to any one type of service in the memory 150.

In various exemplary embodiments, the memory 150 may store a digital assistant client module 157 (hereinafter, referred to as a DA client module), and as a result, the memory 150 may store a command for performing a function of the digital assistant client and various user data 158 (e.g., other data such as user customized vocabulary data, preference data, an electronic address book of a user, a to-do list, a shopping list, etc.).

Meanwhile, the DA client module 157 may acquire a voice input, a text input, a touch input, and/or a gesture input of the user through various user interfaces (e.g., an I/O sub system 140) provided in the 3D graphics interface apparatus 100.

Further, the DA client module 157 may output audiovisual and tactile data. For example, the DA client module 157 may output data constituted by at least two of a voice, a sound, a notice, a text message, a menu, graphics, a video, an animation, and vibration. Moreover, the DA client module 157 may communicate with a digital assistant server (not illustrated) by using a communication sub system 180.

In various exemplary embodiments, the DA client module 157 may collect additional information on a surrounding environment of the 3D graphics interface apparatus 100 from various sensors, sub systems, and peripheral devices in order to configure a context associated with a user input. For example, the DA client module 157 provides context information to the digital assistant server jointly with the user input to infer an intention of the user. Here, the context information that may be accompanied by the user input may include sensor information, e.g., lighting, surrounding noise, a surrounding temperature, an image of the surrounding environment, the video, etc. As another example, the context information may include physical states (e.g., device orientation, a device location, a device temperature, a power level, a speed, an acceleration, a motion pattern, a cellular signal strength, etc.) of the 3D graphics interface apparatus 100. As yet another example, the context information may include information (e.g., a process that is being executed in the 3D graphics interface apparatus 100, an installed program, past and current network activities, a background service, an error log, a resource use, etc.) related to a software state of the 3D graphics interface apparatus 100.

In various exemplary embodiments, the memory 150 may include an added or deleted command, and furthermore, the 3D graphics interface apparatus 100 may also include additional components in addition to the component illustrated in FIG. 1 or also exclude some components.

The processor 120 may control an overall operation of the 3D graphics interface apparatus 100 and perform various commands in order to generate the joint-based facial rig by driving an application or a program stored in the memory 150.

The processor 120 may correspond to an operation device such as a central processing unit (CPU) or an application processor (AP). Further, the processor 120 may be implemented as a type of an integrated chip (IC) such as a system on chip (SoC) wherein various operation devices are integrated such as a neural processing unit (NPU).

In various exemplary embodiments, the processor 120 may generate the facial rig model by morphing at least one morph target in order to represent the facial expression. The processor 120 may generate at least one joint corresponding to each of a plurality of facial areas of the generated facial rig model. Next, the processor 120 may connect at least one generated joint and each of the plurality of facial areas, and then move each of at least one morph target corresponding to the facial rig model. The processor 120 may record a movement change value of the joint moving jointly with each morph target moving.

The peripheral interface 130 is connected to the sub system and the peripheral device to provide data so that the 3D graphics interface apparatus 100 may perform various functions. Here, performing a predetermined function by the 3D graphics interface apparatus 100 may be appreciated as being performed by the processor 120.

In various exemplary embodiments, the 3D graphics interface apparatus 100 may include the communication sub system 180 connected to the peripheral interface 130. The communication sub system 180 may be constituted by one or more wired/wireless networks, and include various communication ports, wireless frequency transceivers, and optical transceivers.

In various exemplary embodiments, the 3D graphics interface apparatus 100 includes an audio sub system 190 connected to the peripheral interface 130, and the audio sub system 190 includes one or more speakers 191 and/or one or more microphones 192, and as a result, the 3D graphics interface apparatus 100 may perform voice operating functions, e.g., voice recognition, voice replication, digital recording, a telephone function, and the like.

In various exemplary embodiments, the 3D graphics interface apparatus 100 may include the I/O sub system 140 connected to the peripheral interface 130. For example, the I/O sub system 140 may control other input/control device 144 included in the 3D graphics interface apparatus 100 through other input controller(s) 142. As an example, the other input controller(s) 142 may control pointer devices such as one or buttons, rocker switches, thumb-wheels, infrared ports, USB ports, and styluses.

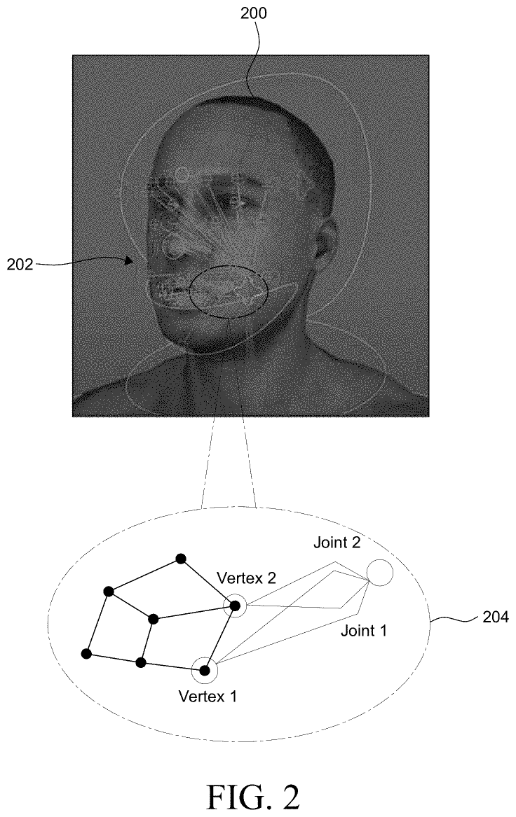

Hereinafter, a method for generating the joint-based facial rig performed by the 3D graphics interface apparatus 100 will be described with reference to FIGS. 2 to 5.

FIGS. 2 to 5 are exemplary diagrams for describing an operation of storing a motion change value of the joint according to an exemplary embodiment of the present disclosure. In the presented exemplary embodiment, the following operations may be achieved by a DCC tool 200 according to a request of the user.

FIG. 2 is an exemplary diagram for describing an operation of generating a joint in a facial rig model according to an exemplary embodiment of the present disclosure.

Referring to FIG. 2, the processor 120 generates a facial rig model 200 by morphing at least one morph target. Here, the generated facial rig model 200 may be expressed as a set of a plurality of meshes constituted by the vertex, the line, and the polygon according to a structure of a facial muscle of an actual person. In various exemplary embodiments, the facial rig model 200 may be a face of a target virtually created by the user other than the actual person. But, the facial rig model 200 is not limited thereto. For example, when the facial rig model 200 is constituted by 500 morph targets, a controller for controlling the morph targets may include attributes of the same name and the same number (i.e., 500). When an attribute value of the controller is changed, the morph target corresponding to the changed value may be morphed as large as the changed value.

Next, the processor 120 generates at least one joint 202 corresponding to each of the plurality of facial areas of the facial rig model 200. The processor 120 connects each facial area and a joint that may be moved by the corresponding facial area. Here, the facial area may be constituted by at least one mesh, but is not limited thereto. The facial area and the mesh may also correspond to each other one to one.

Specifically, the processor 120 may generate the joint for at least one of a plurality of vertexes constituting each of the plurality of facial areas.

For example, when one facial area includes three vertexes, the joint may be generated to correspond to each of three vertexes, the joint may be generated in each of two vertexes among three vertexes, or the joint may be generated in one vertex among three vertexes. However, one joint may be generated in a vertex overlapped by contiguous facial areas among the plurality of facial areas. The method of generating a joint corresponding to the vertex is not limited thereto.

The processor 120 may connect each vertex and a joint of that the movement may be changed jointly according to a movement change of the corresponding vertex. In other words, the processor 120 may connect the joint that may move jointly as a location of each vertex is changed. For example, the control unit 150 may connect Vertex 1 and Joint 1 generated to correspond to Vertex 1 to each other as represented by reference numeral 204, and connect Vertex 2 and Joint 2 generated to correspond to Vertex 2 to each other.

The processor 120 moves each of at least one morph target corresponding to the facial rig model 200. The processor 120 records (or stores) movement change values of a plurality of joints moving jointly according to each of the moving morph targets. In order to move each of at least one morph target, a controller for controlling at least one morph target may be used. The controller may be generated to control each of at least one morph target applied to the generated facial rig model 200. Such a generated controller may include an attribute value corresponding to each of at least one morph target, and at least one morph target may be morphed based on such an attribute value. For example, the attribute value may be the same name and number as the morph target.

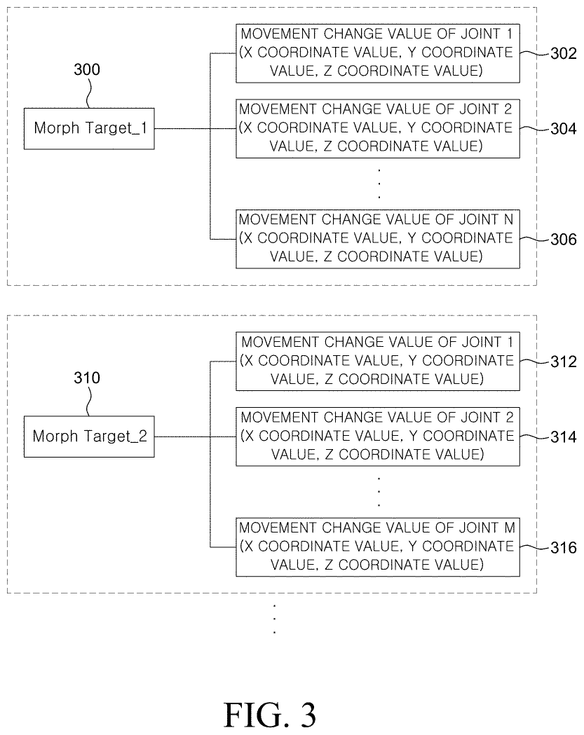

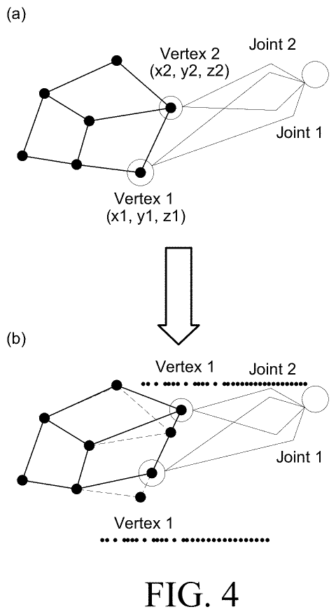

An operation of recording the movement change values of the plurality of joints moving jointly with each moving morph target may be performed for all of the plurality of facial areas constituting the facial rig model 200. The movement change value of each joint is stored in the memory 150. This will be described in detail with reference to FIGS. 3 and 4.

FIGS. 3 and 4 are exemplary diagrams for describing an operation of storing a motion change value of the joint according to an exemplary embodiment of the present disclosure. In the presented exemplary embodiment, it is assumed that the facial rig model 200 is constituted by N morph targets (N>0, natural number).

Referring to FIG. 3, the processor 120 may move a first morph target (Morph_Target_1) 300 by the controller. The processor 120 may record a movement change value (an x coordinate value, a y coordinate value, and a z coordinate value) 302 of the first joint (Joint 1), a movement change value 304 of the second joint (Joint 2), . . . , a movement change value 306 of an n-th joint (Joint n) (n>0) moving jointly according to the moving first morph target 300. This will be described in detail with reference to FIG. 4.

Referring to FIG. 4A, Joint 1 having a coordinate value (x1, y1, z1) is connected to correspond to Vertex 1, and Joint 2 having a coordinate value (x2, y2, z2) is connected to correspond to Vertex 2. Referring to FIG. 4B, as the first morph target 300 moves, a coordinate value of Joint 1 moves to (x1′, y1′, z1′), and a coordinate value of Joint 2 moves to (x2′, y2′, z2′). The processor 120 may store the movement change value of each joint to correspond to the first morph target 300 in a format such as ‘MorphTarget_1:, [joint1: x coordinate value, y coordinate value, z coordinate value, joint2: x coordinate value, y coordinate value, z coordinate value, . . . ]’. In the presented exemplary embodiment, two joints are described to correspond to the first morph target 300, but the present disclosure is not limited thereto. A movement change values for all joints moving jointly may be stored in relation to the first morph target 300 moving. In various exemplary embodiments, a format of the stored movement change value is not also limited as described above. Various data formats (e.g., vector values) may be used.

Next, the processor 120 may move a second morph target (Morph_Target_2) 310 by the controller. The processor 120 may record the movement change value (an x coordinate value, a y coordinate value, and a z coordinate value) 312 of Joint 1, a movement change value 314 of Joint 2, . . . , a movement change value 316 of Joint m (m>0) moving jointly according to the moving second morph target 310. The operations may be performed as large as the number of one or more morph targets constituting the facial rig model 200.

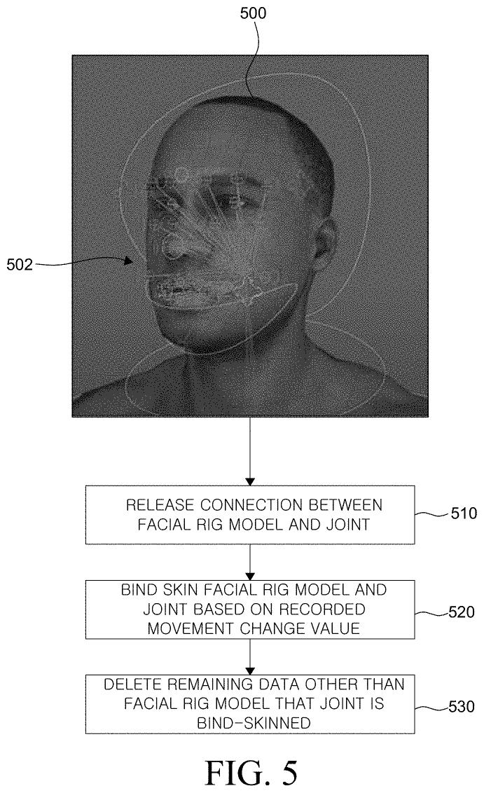

FIG. 5 is an exemplary diagram for describing a method for generating a joint-based facial rig model according to an exemplary embodiment of the present disclosure.

Referring to FIG. 5, the processor 120 releases a connection with the corresponding joint 502 in the facial rig model 500 of that the joint 502 is connected (510). For example, with respect to the facial rig model 500, when Vertex 1 and Joint 1 are connected, the processor 120 may release the connection between Vertex 1 and Joint 1. Such an operation may be performed for all of the joints connected in relation to the facial rig model 500.

Next, the processor 120 bind-skins the facial rig model 500 and the joint (i.e., a connection-released joint) based on the recorded movement change value (520). Here, the bind skin means an operation of setting the form of the model to move according to the movement of the joint. In other words, the processor 120 may set the joint corresponding to each of the plurality of facial areas constituting the facial rig model 500 to move according to the recorded movement change value. For example, the processor 120 may set each of Vertex 1 to Vertex n constituting the facial rig model 500 to move according to the movement change value of each of Joint 1 to Joint n.

Next, the processor 120 deletes remaining data other than the facial rig model 500 of that the joint is bind-skinned (530). Specifically, the processor 120 may exclude a set of meshes constituting the facial rig model of that the joint is bind-skinned. The processor 120 may delete the remaining data including at least one morph target applied to the facial rig model 500 and at least one of the morphing rigs corresponding to each morph target.

As such, the joint-based facial rig model is generated by using the morphing (or morphing target)-based facial rig model, the amount of the stored data may reduce compared to the morphing-based facial rig model. In addition, it is possible to provide a facial rig model capable of a processing the amount of calculation at a high speed and capable of real-time processing.

In various exemplary embodiments, when the attribute value of the controller controlling each morph target is changed, the processor 120 may move each joint in response to the changed attribute value. Specifically, the processor 120 determines a location value for each joint by using the movement change value of at least one joint corresponding to the changed attribute value. The processor 120 moves each joint with the determined location value. Here, the processor 120 may calculate a total sum for the movement change values of one or more joints corresponding to a name that is the same as the name (e.g., ‘Morph_Target_2’, etc.) of the changed attribute value. The processor 120 may determine the location value of each joint by using the calculated total sum.

Therefore, the facial rig model bind-skinned with at least one joint may express the detailed and delicate movement as if using the morphing-based facial rig model.

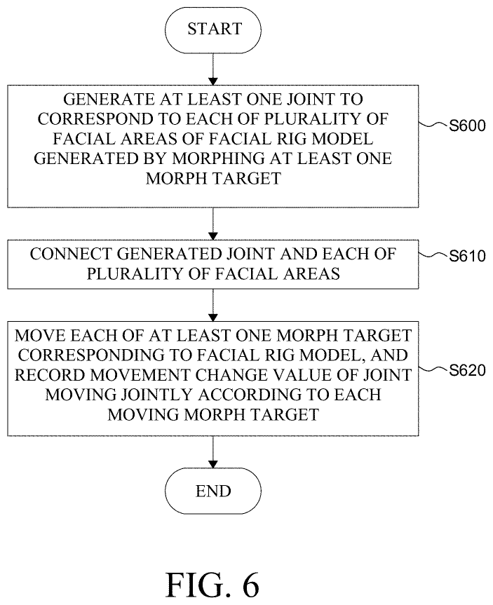

FIG. 6 is a flowchart for describing a method for generating a joint-based facial rig model according to an exemplary embodiment of the present disclosure. In the presented exemplary embodiment, an operation to be described below may be performed by the processor 120.

Referring to FIG. 6, the processor 120 generates at least one joint to correspond to each of a plurality of facial areas of a facial rig model generated by morphing at least one morph target (S600). The processor 120 may connect the generated joint and each of the plurality of facial areas (S610). The processor 120 may move each of at least one morph target corresponding to the facial rig model, and record a movement change value of the joint moving jointly with each morph target moving (S620).

In various exemplary embodiments, the processor 120 may release the connection between the each facial area of the facial rig model and the joint. The processor 120 may bind-skin the joint connection-released from the facial rig model based on the recorded movement change value. Next, the processor 120 may delete remaining data other than the facial rig model of that the joint is bind-skinned. Here, the remaining data may include at least one morph target and at least one of morphing rigs corresponding to at least one morph target.

In various exemplary embodiments, the processor 120 may generate a controller for controlling at least one morph target. The generated controller may include an attribute value corresponding to each of at least one morph target. At least one morph target may be morphed based on the corresponding attribute value.

In various exemplary embodiments, when the attribute value of the morph target is changed, the processor 120 may determine a location value for each joint by using the movement change value of at least one joint corresponding to the attribute value. The processor 120 may move each joint with the determined location value.

In general, a realistic or stylistic model has thousands to hundreds of thousands of vertexes. Here, when dozens or hundreds of morph targets are morphed, the number of vertexes to be calculated may become the number acquired by multiplying the number of vertexes for a model having a basic facial form by the number of morph targets. However, the joint may change the form of the model by moving the number of one dozens-th to one hundreds-th of the number of the vertexes. When the number of joints becomes one of hundreds-th of the number of vertexes, a calculation amount when changing the form of the model may also be reduced to one hundredth.

Accordingly, in the joint-based facial rig model according to the exemplary embodiment of the present disclosure, a joint corresponding to several tenths to several hundredths can be moved compared to thousands to hundreds of thousands of vertexes constituting the facial rig model move. That is, when the face shape(Action unit) is transformed, the amount of computation to be processed or the amount of data to be stored can be significantly reduced.

Further, in the joint-based facial rig model according to the exemplary embodiment of the present disclosure, since the processing speed is fast, the real-time processing is possible.

In addition, in the joint-based facial rig model according to the exemplary embodiment of the present disclosure, the detailed and delicate movement may be expressed similarly to the time of using the morph target.

The apparatus and the method according to the exemplary embodiments are implemented in a form of a program command that may be performed through various computer means and may be recorded in the computer readable medium. The computer readable medium may include singly a program command, a data file, or a data structure or a combination thereof.

The program command recorded in the computer readable medium may be program instructions specially designed and configured for the present disclosure, or may be program instructions publicly known to and used by those skilled in the computer software field. An example of the computer readable recording medium includes magnetic media such as a hard disk, a floppy disk, and a magnetic tape, optical media such as a CD-ROM and a DVD, magneto-optical media such as a floptical disk, and hardware devices such as a ROM, a RAM, and a flash memory, that are specially configured to store and execute the program command. An example of the program command includes a high-level language code executable by a computer by using an interpreter and the like, as well as a machine language code created by a compiler.

The above-described hardware device may be configured to be operated with one or more software modules in order to perform the operation of the present disclosure and vice versa.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present disclosure are provided for illustrative purposes only but are not intended to limit the technical concept of the present disclosure. The scope of the technical concept of the present disclosure is not limited to the exemplary embodiment. Therefore, it should be understood that the above-described exemplary embodiments are illustrative in all aspects and do not limit the present disclosure. The protection scope of the present disclosure should be construed based on the following appended claims and it should be appreciated that the technical spirit included within the scope equivalent to the claims belongs to the present disclosure.

What is claimed is:

1. A method for generating a joint-based facial rig performed by a control unit, the method comprising:
generating a facial rig model by morphing at least one morph target in order to represent a facial expression;
generating at least one joint corresponding to each of a plurality of facial areas of the generated facial rig model;
connecting the at least one generated joint and each of the plurality of facial areas; and
moving each of the at least one morph target corresponding to the facial rig model, and recording a movement change value of a joint moving jointly according to the each moving morph target.

2. The method according to claim 1, comprising:
releasing a connection between each of the plurality of facial areas of the facial rig model and the joint; and
bind-skinning the joint connection-released from the facial rig model based on the recorded movement change value.

3. The method according to claim 2, further comprising:
deleting remaining data other than the facial rig model that the joint is bind-skinned.

4. The method according to claim 3, wherein the remaining data includes the at least one morph target and at least one of morphing rigs corresponding to at least one morph target.

5. The method according to claim 1, wherein the generating of the facial rig model further includes generating a controller for controlling the at least one morph target,
the generated controller includes an attribute value corresponding to each of the at least one morph target, and
the at least one morph target is morphed based on the attribute value.

6. The method according to claim 5, further comprising:
determining a location value for each joint by using a movement change value of at least one joint corresponding to the attribute value when the attribute value is changed; and
moving the each joint with the determined location value.

7. A 3D graphics interface apparatus, comprising:
a storage unit; and
a processor configured to generate a facial rig model by morphing at least one morph target in order to represent a facial expression in connection with the storage unit,
wherein the processor is configured to
generate at least one joint corresponding to each of a plurality of facial areas of the generated facial rig model,
connect the at least one generated joint and each of the plurality of facial areas, and
operate each of the at least one morph target corresponding to the facial rig model, and record a movement change value of a joint moving jointly according to the each operating morph target.

8. The 3D graphics interface apparatus according to claim 7, wherein the processor is configured to
release a connection between each of the plurality of facial areas of the facial rig model and the joint, and
bind-skin the joint connection-released from the facial rig model based on the recorded movement change value.

9. The 3D graphics interface apparatus according to claim 8, wherein the processor is further configured to delete remaining data other than the facial rig model of that the at least one joint is bind-skinned.

10. The 3D graphics interface apparatus according to claim 9, wherein the remaining data includes the at least one morph target and at least one of morphing rigs corresponding to the at least one morph target.

11. The 3D graphics interface apparatus according to claim 7, wherein the control unit is further configured to generate a controller for controlling the at least one morph target,
the generated controller includes an attribute value corresponding to each of the at least one morph target, and
the at least one morph target is morphed based on the attribute value.

12. The 3D graphics interface apparatus according to claim 11, wherein the processor is configured to
determine a location value for each joint by using a movement change value of at least one joint corresponding to the attribute value when the attribute value is changed, and
move the each joint with the determined location value.
